(19) United States
(12) Patent Application Publication
(10) Pub. No.: US 2004/0019676 A1
(43) Pub. Date: Jan. 29, 2004

(54) Network operation monitoring system

(75) Inventors: Takumi Iwatsuki, Osaka (JP); Masaki Mishima, Osaka (JP); Atsushi Hattori, Osaka (JP); Kei Higuchi, Yokkaichi (JP); Mitsuhiko Watanabe, Osaka (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/308,123

(22) Filed: Dec. 3, 2002

(30) Foreign Application Priority Data
Jul. 23, 2002 (JP) 2002-213291

(51) Int. Cl. G06F 15/173

(52) U.S. Cl. 709/224

(57) ABSTRACT

A network operation monitoring system comprising a memory unit for storing network status information in a time series with respect to each operation performed by an operator on a network or with respect to each transition in events, a retrieval unit for retrieving the network status information stored in the memory unit in a time-dependant manner according to the operator's instruction, and a display unit for displaying the network status information retrieved by the retrieval unit in the time-dependant manner according to the operator's instruction.

### BACKGROUND OF THE INVENTION

1. Field of the Invention

The present invention relates to a network operation monitoring system having a function of retrieving and displaying an event occurring in a network in-the past. In particular, the present invention relates to a network operation monitoring system having a function of providing useful information when disconnecting a failure location, forecasting demand, and updating the network for the network operation management.

2. Description of the Related Art

Now that the network, such as a communication network, the Internet, an intranet, a local area network, and a public switched network, has become a lifeline for business enterprises, it is required to grasp failure status, traffic status, device response time, etc. on a regular basis and to quickly deal with a problem, if any, for stable operation of the network. In order to cope with such requirements, various types of network operation monitoring systems may be applied. These systems, in general, are intended to display the operating condition of the network. In general, other systems such as a network analyzer, etc. are employed for disconnecting the failure location and forecasting the demand, etc.

However, in such a network operation monitoring system according to the related art, when a problem arises, an operator of the network checks, while counting on his own skill, the operating condition at each point in the network and log of events (collection data) reported by each device in the network so as to grasp the overall picture of the problem. However, with the recent expansion of networks and the increase in the complexity of the network itself, a lot of work and high-leveled skills must be devoted in order to investigate the cause of the problem after its manifestation.

The present invention intends to effectively lower the skill level required when investigating the cause and location of such problems and forecasting demand. Also, the present invention intends to enable network operation monitoring that is sensuously understandable to human beings.

### SUMMARY OF THE INVENTION

In view of the above-mentioned problem, an object of the present invention is to provide a network operation monitoring system by which it becomes possible to retrieve the network status in the past in a manner such, that an operator may easily locate a trouble source location and/or may effectively make future planning on the network.

The network operation monitoring system according to the present invention includes a memory unit for storing network status information in a time series with respect to each operation performed by the operator on the network or with respect to each transition in events, a retrieval unit for retrieving the network status information stored in the memory unit in a time-dependant manner according to the operator's instruction, and a display unit for displaying the network status information retrieved by the retrieval unit in the time-dependant manner according to the operator's instruction.

By configuring the system as mentioned above, it is possible to retrieve the network status in the past since the network status information is stored in the memory unit with respect to each operation performed by the operator on the network or with respect to each transition in events in the time series.

The system according to the present invention may further include a unit for designating a certain event or certain network status as a retrieval start point and a retrieval finish point when displaying the network status information retrieved in the time-dependant manner according to the operator's instruction.

By configuring the system as mentioned above, it is possible to retrieve and display the operating condition of the network from the retrieval start point to the retrieval finish point, both designated by such a unit for designating a certain event or certain network status.

The system according to the present invention may further include a unit for controlling a display rate with respect to real event progress time scale when displaying the network status information retrieved in the time-dependant manner according to the operator's instruction.

By configuring the system as mentioned above, it is possible to display the network status information with controlled/varying display rates.

The system according to the present invention may further include a unit for retrieving and displaying the network status information retrieved in the time-dependant manner according to the operator's instruction with respect to a network physical configuration or a network logical configuration.

By configuring the system as mentioned above, the network status information in the past can be displayed with respect to the network physical configuration or the network logical configuration.

The system according to the present invention may further include a unit for controlling display manner of measured status with respect to the network. The measured status with respect to the network comprises measured response time of a node, and is represented as distance between nodes or color of a display line connecting the nodes displayed on the monitoring screen in proportion to the measured response time, and an amount of traffic of a link connecting between nodes in the network, and is represented as color or thickness of a display line representing the link displayed on the display unit in proportion to the amount of measured traffic.

By configuring the system as mentioned above, it is possible to retrieve and display the response time as the distance between the nodes or the color of the display line connecting between the nodes displayed on the monitoring screen.

By configuring the system as mentioned above, it is possible to retrieve and display the amount of traffic as the thickness or the color of the display line representing the link in the network displayed on the monitoring screen.

### BRIEF DESCRIPTION OF THE DRAWINGS

Other objects, advantages, and further features of the present invention will become more apparent as the description proceeds taken in conjunction with the accompanying drawings in which:

FIG. 1 illustrates a position of a network operation monitoring system in a communication network;

FIG. 2 shows one conceivable example of a network monitoring screen of such a network operation monitoring system;

FIG. 3 shows one conceivable example of an information management scheme in the network operation monitoring system;

FIG. 4 shows a basic principle block diagram of one embodiment of the present invention;

FIG. 5 shows an example of an event-recording database according to the embodiment of the present invention;

FIG. 6 is a diagram illustrating event information and an object according to the embodiment of the present invention;

FIG. 7 is a diagram illustrating the recording of network information according to the embodiment-of the present invention;

FIG. 8 is a diagram illustrating addition of a node and a link according to the embodiment of the present invention;

FIG. 9 is a diagram illustrating the addition of a node and a link, and updating (addition) of the database according to the embodiment of the present invention;

FIG. 10 is a diagram illustrating deletion of an edge according to the embodiment of the present invention;

FIG. 11 is a diagram illustrating the deletion of an edge and updating (deletion) of the database according to the embodiment of the present invention;

FIG. 12 is a diagram illustrating a change of registered information of a node according to the embodiment of the present invention;

FIG. 13 is a diagram illustrating the change of the registered information of a node and updating of the database according to the embodiment of the present invention;

FIG. 14 is a diagram illustrating recording of network status according to the embodiment of the present invention;

FIG. 15 is a diagram illustrating the recording of the network status and registration of a network object at time t according to the embodiment of the present invention;

FIG. 16 is a diagram illustrating retrieval of the network status according to the embodiment of the present invention;

FIG. 17 is a diagram illustrating the retrieval of the network status according to the embodiment of the present invention;

FIG. 18 is a diagram illustrating recording and retrieval of the network status according to the embodiment of the present invention;

FIG. 19 is a diagram illustrating retrieval of events occurred in the past according to the embodiment of the present invention;

FIG. 20 shows a first example of the network status display screen according to the embodiment of the present invention;

FIG. 21 shows a second example of the network status display screen according to the embodiment of the present invention;

FIG. 22 shows a third example of the network status display screen according to the embodiment of the present invention;

FIG. 23 shows a fourth example of the network status display screen according to the embodiment of the present invention, and

FIG. 24 shows a block diagram of a computer, which carries out a method according to the present invention when a medium including such a method is loaded in a drive of the computer.

### DETAILED DESCRIPTION OF THE PREFERRED EMBODIMENTS

A preferred embodiment of the present invention will be described. First, a basic concept of a network operation monitoring system in the embodiment of the present invention will now be described.

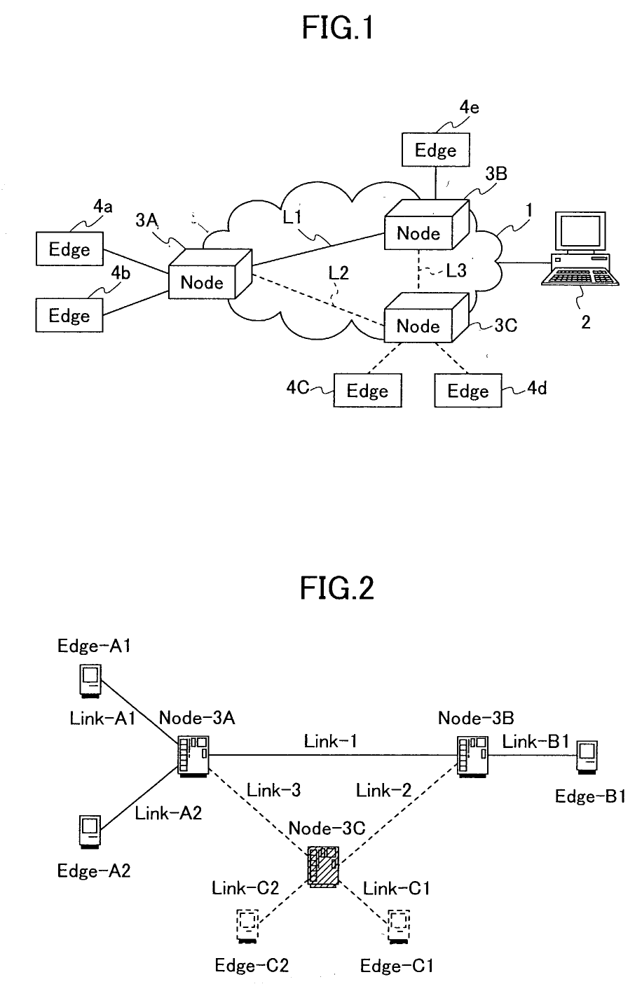

The network operation monitoring system displays the status of various nodes and lines in a network of the present moment on a display screen based on physical network configuration and logical network configuration information. The status of various nodes and lines is generally realized by messages from the devices in the network or by collecting information of the devices on a regular basis by the network operation monitoring system. An operator in charge of the network can obtain primary information of the presence/absence of a failure and primary information for disconnecting the failure location by grasping overall network status of the present moment from the information displayed on the monitoring system. The following is a description of operations of a conceivable example of such a network operation monitoring system made with reference to FIG. 1 through FIG. 3.

FIG. 1 illustrates a position of the network operation monitoring system. In FIG. 1, a reference numeral 1 represents a network 1 and a reference numeral 2 represents a network operation monitoring system 2 connected to the network 1. Reference numerals 3A through 3C are nodes configuring the network 1 and reference numerals 4a through 4e are edges (terminal devices) connected to the nodes 3A through 3C, respectively.

A reference numeral L1 represents a link between the node 3A and the node 3B; a reference numeral L2 represents a link between the node 3A and the node 3C, and a reference numeral L3 represents a link between the node 3B and the node 3C. The network operation monitoring system 2 is, for example, connected to the node 3B within the network 1.

It is assumed that a failure has been occurred at the node 3C in the system configured as mentioned above. The network operation monitoring system 2 recognizes the failure occurred at the node 3C. As a result, the operation status of the edges 4c and 4d connected to the node 3C becomes unknown. The operation status of the link L2 and the link L3 also becomes unknown. In FIG. 1, solid lines represent those elements operating normally and broken lines represent those whose operation status is not known.

By receiving messages from each device in the network or by collecting the information of each device in the network on a regular basis, the network operation monitoring system 2 can obtain network information and display it on the display screen of the network operation monitoring system 2.

FIG. 2 shows a network monitoring screen of the network operation monitoring system displayed as mentioned above. Node-3C where the failure is believed to have occurred is displayed as shaded and Link-2 and Link-3 connected to Node-3C are also displayed as status unknown. Edge-C1 and Edge-C2 associated with Node-3C, as well as Link-C1 and Link-C2 connecting Node 3C to Edge-C1 and Edge-C2, respectively, are displayed in broken lines since their operation status is unknown.

In the network operation monitoring system, only the information at the present is displayed on the network monitoring screen when displaying the operating condition of the network. Therefore, if the failure affects the network over a wide range, it is difficult to determine the specific device or the specific line where the failure has occurred from the screen only displaying the current network status. Normally, when encountering such a situation, it is necessary to disconnect the failure location by making reference to the log maintained by the network operation monitoring system 2 while counting on the experience of the operator.

Also, with respect to the trends of traffic over the network and response time of nodes and servers as opposed to determining the failure location, the operator has to analyze the trends of traffic over the network after making reference to the information collected from each device in the network. Therefore, the experience and the skill of the operator are needed in order to grasp the overall picture of the network.

In the network operation monitoring system, various types of information related to the network status and the network configuration change, etc. are maintained independently. Therefore, when the failure arises, the operator of the network has to analyze each type of information individually in order to determine the cause of the failure and perform the corresponding procedure.

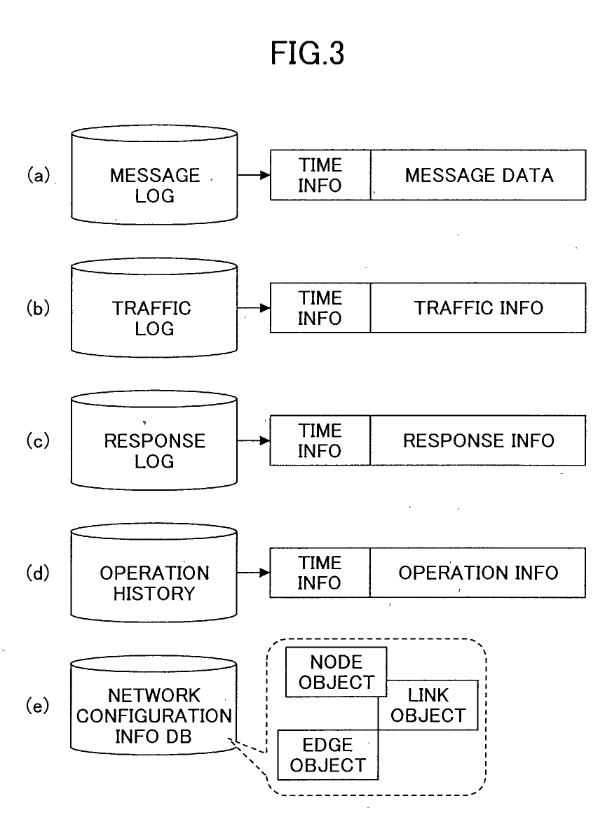

FIG. 3 shows information management in the network operation monitoring system. The information,management of the network operation monitoring system comprises (a) a message log, (b) a traffic log, (c) a response log, (d) an operation history, and (e) a network configuration information database (DB). These elements are connected to the network operation monitoring system.

The message log records status change message from a router, a switch, a hub, or a server, etc. and is used as information for failure analysis by the operator. The traffic log records measurement results of the traffic and is used for generating inputs for a traffic status display screen (graphs, etc.). The response log records measurement results of the response time and is used for generating inputs for a response time display screen (graphs, etc.). The operation history records details of the operations performed by the operator and are used as information for checking the details of operations performed and for failure analysis. The network configuration information database (DB) records the elements of the network and their status and is used as information for map representation of the network.

The message log comprises time information and message data. The time when the network operation monitoring system received the message from a node, etc. is recorded in the time information. Information of the messages sent from the node, etc. is recorded in the message data. The traffic log comprises time information and traffic information. The time when the traffic measurement is collected is recorded in the time information.

The response log comprises time information and response information. The time when the response time is observed is recorded in the time information. The operation history comprises time information and operation information. The time when the operator performed an operation is recorded in the time information. The network configuration information database (DB) stores the latest network configuration and status as objects (information of objects). Node objects record information such as the location of logical lines with respect to the physical connection ports. Link objects record information of how the nodes are connected to one another. Edge objects record information of how an edge is connected and which link is used for the connection.

However, in the above-described configuration, the network configuration information database only maintains information at the present. Therefore, the network operation monitoring system cannot retrieve and display the status in the past. In other words, since the network configuration information in the past cannot be retrieved, even when traced back in the message log, etc., the information from the log cannot be applied so as to reflect back to the network configuration at a point of time in the past.

The present invention is directed to improve the network operation monitoring system in the above-mentioned example.

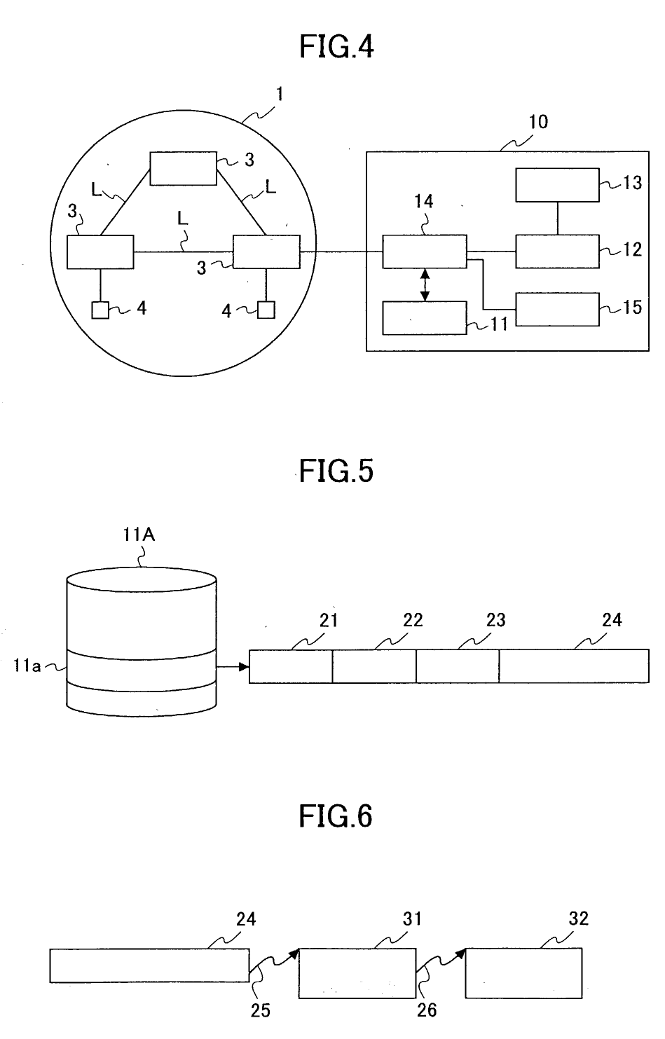

FIG. 4 shows a principle block diagram of an embodiment of the present invention. Elements identical to those shown in FIG. 1 are denoted with the same reference numerals. In FIG. 4, 1 represents a network and 10 represents a network operation monitoring system connected to the network 1 for monitoring the operating condition of the network 1. Within the network 1, 3 represents a node, 4 represents an edge connected to the node 3, and L represents a link connecting nodes 3 to one another. Here, the node is to mean a device corresponding to a branch point or a relay point of a line, accommodating a plurality of lines in the network (for example, a router or a switch, etc.), the edge is to mean a device located at the end of the network and terminating the network (for example, a server or a client terminal, etc.).

The network operation monitoring system 10 includes a memory unit 11 for storing network status information in a time series with respect to each operation performed by an operator on the network 1 or with respect to each transition in events, a retrieval unit 12 for retrieving the event of the network in a time series or in a reverse time series from the time designated by the operator, a display unit 13 for displaying the event retrieved by the retrieval unit 12 on a monitoring screen, a control unit 14 for controlling an overall operation of the network operation monitoring system 10, and a manipulation unit 15 for inputting various commands, etc. to the control unit 14.

According to the configuration as mentioned above, it is possible to retrieve the network status in the past by precedently storing the network status information in the time series with respect to each operation performed by the operator on the network 1 or with respect to each transition in events. The following is a detailed description on how the retrieval and the display of the network status in the past are made possible.

Records of messages according to the status of various nodes, connections, physical links, and logical links located in the network 1 and information of traffic and response time are registered in the memory unit (database) 11 as the network event log (collection data) along with time information when the network event log is obtained. The operations (registration, blockage, and deletion of nodes and lines, etc.) performed by the operator are also recorded in the network event log.

FIG. 5 shows an example of the memory unit 11 described in FIG. 4 in the form of an event-recording database 11A. The event-recording database 11A comprises a record 11a comprising an event number 21, time information 22, key information 23, and event information (details) 24.

The event number 21 may be a serial value of a record number, for example. The time information 22 is the time when the event occurred (date, hour, minute, and second), for example. The key information 23 is additional information for a search or marking the event, for example. The event information 24 is detailed information of the event occurred, for example. This record 11a is provided for every event.

According to the present invention, the event information 24 is provided with a pointer (link) to the event occurred and to the object (information of the object: information of the line, for example) related to the event, if necessary.

FIG. 6 is a diagram illustrating the event information 24 and the objects according to the embodiment of the present invention. The event information 24 and its related detailed objects 31, 32 are all stored in the event-recording database 11A. The event information 24 is associated with the object 31 via a link 25 and the object 31 is associated with another object 32 via a link 26, if necessary. Therefore, it is possible to store the event information 24 associated with the objects.

The following are the various types of objects.

(a) Node object: information representing a nodal point on the network such as a router, a switch, a hub, and a server, etc.

(b) Edge object: information representing a terminal device such as a personal computer, etc.

(c) Physical link object: information representing a physical line connecting the nodes.

(d) Logical link object: information representing a logical connection over the physical line.

(e) Connection object: information representing a logical connection from end to end.

(f) Status object: information of a certain status.

(g) Operation history object: information representing the operations performed by the operator.

(h) Traffic object: information representing the amount of information transmitted over the links or the connections.

(i) Response time object: information representing response time of the nodes.

As mentioned, every time when an event of various types occurs, the event is recorded in the event-recording database 11A and the pointer (link) is established so that an object related to the event can be referred to. By adopting such a data structure, it is possible to consolidate the events occurred in the network and the operation history of the operator into a time series.

In addition, since the information of the elements configuring the network 1 can be maintained independently, there is no problem concerning editing the objects (addition, deletion, etc.), when registering a node and a link, etc.

According to the present invention, by storing the network status information in a time series in the event-recording database 11A with respect to each operation performed by the operator on the network 1 or with respect to each transition in events, it is possible to read out the contents of the event-recording database 11A, to retrieve the network status in the past using the retrieval unit 12, and to display the network status in the past on the display unit 13.

The following is a description of the recording of the network configuration information. The network operation monitoring system according to the example mentioned above maintains only the latest network configuration information. The latest network configuration information is sufficient for displaying the current status of the network. However, in order to be able to retrieve and display the operating condition of the network, it is necessary to maintain the network configuration information in the past as well. According to the present invention, it is possible to retrieve the network operating condition in the past by recording the transitions/changes in the network configuration information.

The retrieval of the network operating condition of the past is realized, when a change is made to the node or link, etc., by storing the information before the change as “information in the past” and the information after the change as “information at the present” in the memory unit 11.

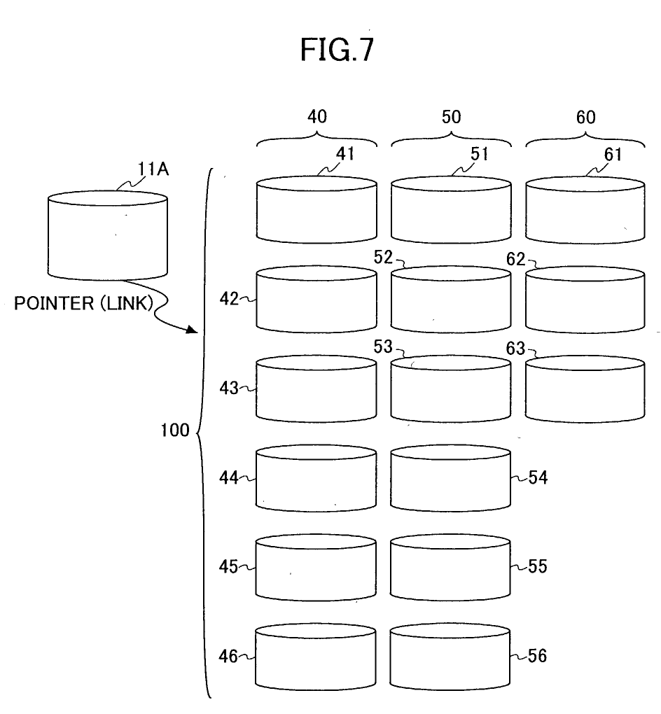

FIG. 7 is a diagram illustrating the recording of network information according to the embodiment of the present invention. Elements identical to those shown FIG. 5 are denoted with the same reference numerals. In FIG. 7, the reference numeral 100 represents a group of network information objects. The group of network information objects 100 is configured of information at the present 40, information in the past 50, and history information 60, which are all stored in the event-recording database 11A.

The information at the present 40 is configured of a group of node objects 41, a group of edge objects 42, a group of physical link objects 43, a group of logical link objects 44, a group of connection objects 45, and a group of status objects 46. The information in the past 50 is configured of a group of node objects 51, a group of edge objects 52, a group of physical link objects 53, a group of logical link objects 54, a group of connection objects 55, and a group of status objects 56 similar to the information at the present 40 The history information 60 is configured of a group of operation history objects 61, a group of traffic objects 62, and a group of response time objects 63. The group of operation history objects 61 stores, for example, information indicating removal of a node A. The group of traffic objects 62 stores the amount of information transmitted over a link or a connection. The group of response time objects 63 stores the response time of a node or an edge, etc. These groups of objects and the event-recording database 11A are associated with one another by a pointer (link). Therefore, the detailed information of a certain event can be read out from the groups of the objects.

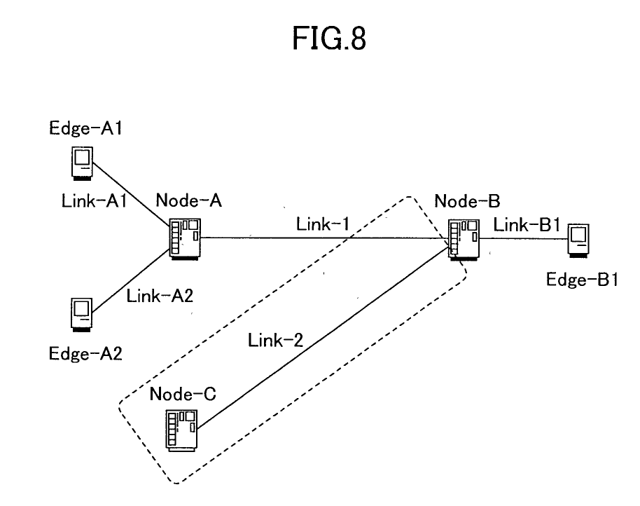

FIG. 8 is a diagram illustrating the addition of a node and a link according to the embodiment of the present invention. The displaying method of the node and the link is the same as in FIG. 2 and there is shown the display screen (display unit) of the network operation monitoring system 10. Particularly, the control unit 14 reads out the contents in the memory unit 11, and the contents are retrieved by the retrieval unit 12 and displayed by the display unit 13.

The node and link addition sequence is established by the operator via the manipulation unit 15. When the control unit 14 receives the sequence, it initiates the node and the link addition process. In the network system as shown in FIG. 8, Node-A and Node-B are connected by Link-1. Edge-A1 is connected to Node-A via Link-Al and Edge-A2 is connected to Node-A via Link-A2. Edge-B1 is connected to Node-B via Link-B1.

The following is a description of the registering Node-C and Link-2 in the network operation monitoring system 10 configured as mentioned above. The following is the registration sequence of Node-C and Link-2.

1. Generate Node-C and store its information (objects) in the event-recording database 11A.

2. Collect an operating condition of Node-C and reflect and register the collected operating condition to the event-recording database 11A.

3. Generate Link-2 and store its information (objects) in the event-recording database 11A.

4. Collect an operating condition of Link-2 and reflect and register the collected operating condition to the event-recording database 11A.

By doing so, the information related to Node-C and Link-2 is registered to the network operation monitoring system.

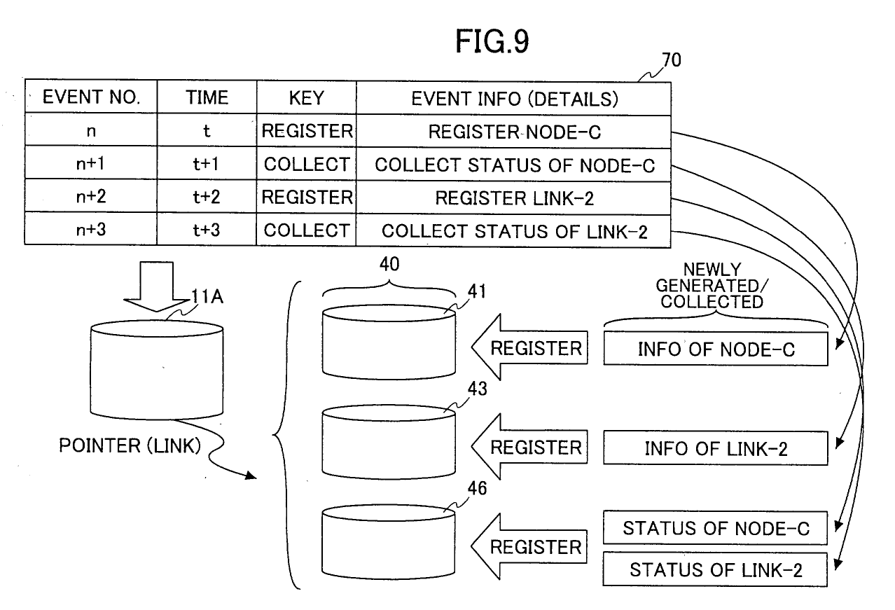

FIG. 9 is a diagram illustrating in detail the addition of the node and the link and updating (addition) of the event-recording database 11A according to the embodiment of the present invention. Elements identical to those shown in FIG. 7 are denoted with the same reference numerals. In FIG. 9, a sequence 70 represents the addition of Node-C and Link-2 to the network as shown in FIG. 8. The event number, the time information, the key information, and the event information (details) with respect to each event are stored in the event-recording database 11A. At the event number n, an event of registering Node-C to the network occurs at time t. Since the information of Node-C is newly generated and collected (Key is to register), it is registered to the group of node objects 41 of the information at the present 40.

Then, at event number n+1, an event of obtaining the status of Node-C occurs at time t+1. Since the status of Node-C is newly generated and collected (Key is to collect), it is registered to the group of status objects 46 of the information at the present 40. Then, at event number n+2, an event of registering the physical Link-2 occurs at time t+2. Since information of Link-2 is newly generated and collected (Key is to register), it is registered to the group of physical link objects 43 of the information at the present 40. Then, at event number n+3, an event of obtaining the status of the physical Link-2 occurs at time t+3. Since the status of Link-2 is newly generated and collected (Key is to collect), it is registered to the group of the status objects 46 of the information at the present 40. For registering Node-C and Link-2, the contents of the sequence 70 is stored in each record of the event-recording database 11A and the detailed event information of each record is associated with each group of objects by a pointer (link). Therefore, it is possible to read out the contents of the event-recording database 11A and display the contents on the display screen (display unit 13). The contents displayed on the screen are as shown in FIG. 8.

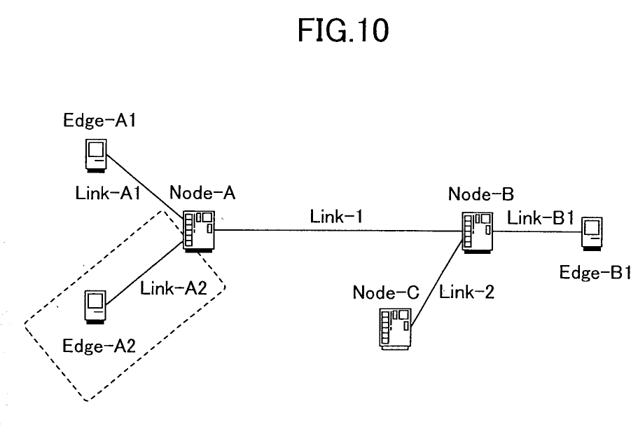

FIG. 10 is a diagram illustrating the deletion of an edge according to the embodiment of the present invention. The displaying method of the node and the link is the same as shown in FIG. 2 and there is shown the display screen of the network operation monitoring system 10. An edge deletion process is initiated by the operator sending a deletion sequence from the manipulation unit 15 to the control unit 14. In the network system shown in FIG. 10, Node-A and Node-B are connected to each other by Link-1. Node-B and Node-C are connected to each other by Link-2. Edge-B1 is connected to Node-B via Link-B1. Edge-A1 is connected to Node-A via Link-A1 and Edge-A2 is connected to Node-A via Link-A2.

The following is the deletion sequence of Edge-A2. The subject of the operation is the network operation monitoring system 10.

1. Move the information of Edge-A2 to the information in the past (see 50 of FIG. 7) for deletion.

2. Move the information of Link-A2 connected to Edge-A2 to the information in the past for deletion.

3. Move the status of Link-A2 to the information in the past for deletion.

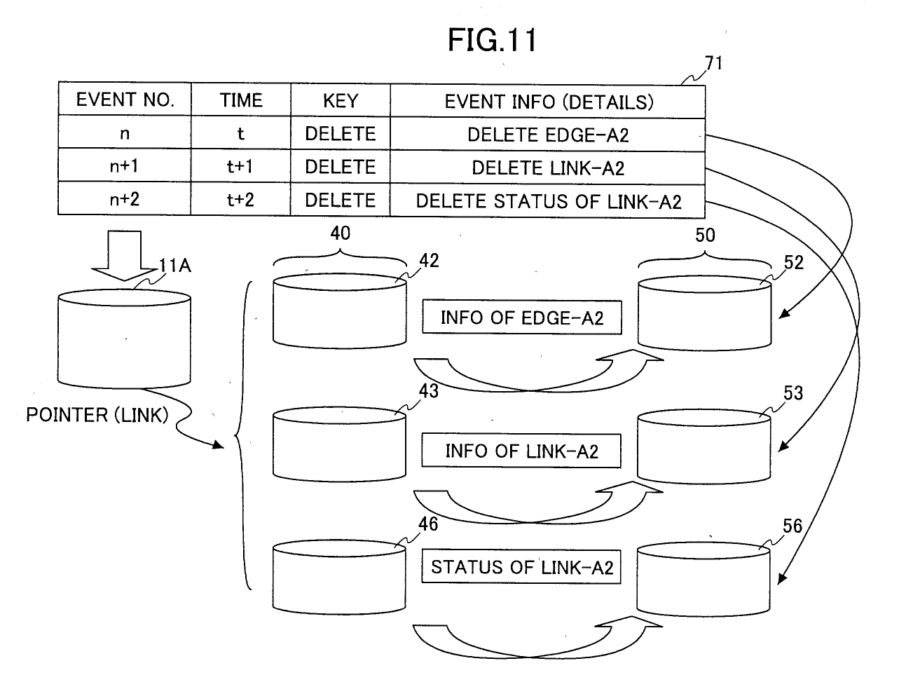

FIG. 11 is a diagram illustrating the deletion of the edge and updating (deletion) of the event-recording database 11A according to the embodiment of the present invention. The elements identical to those shown in FIG. 7 are denoted with the same reference numerals. In FIG. 11, a sequence 71 represents the deletion of the edge from the network as shown in FIG. 10. The event number, the time information, the key information, and the event information (details) with respect to each event are stored in the event-recording database 11A. At event number n, an event of deleting Edge-A2 occurs at time t. Since the information of Edge-A2 is to be deleted (Key is to delete), it is moved from the group of edge objects 42 of information at the present 40 to the group of edge objects 52 of the information in the past 50.

Then, at event number n+1, an event of deleting Link-A2 occurs at time t+1. Since the information of Link-A2 is to be deleted (Key is to delete), it is moved from the group of physical link objects 43 of the information at the present 40 to the group of physical link objects 53 of the information in the past 50. Then, at event number n+2, an event of deleting the status of Link-A2 occurs at time t+2. Since the status information of the Link-A2 is to be deleted (Key is to delete), it is moved from the group of status objects 46 of the information at the present 40 to the group of status objects 56 of the information in the past 50.

For deleting Edge-A2 and Link-A2, the contents of the sequence 71 are stored in each record of the event-recording database 11A and the detailed information of each record is associated with each group of objects by a pointer (link). Therefore, it is possible to read out the contents of the event-recording database 11A and display them on the display screen (display unit 13).

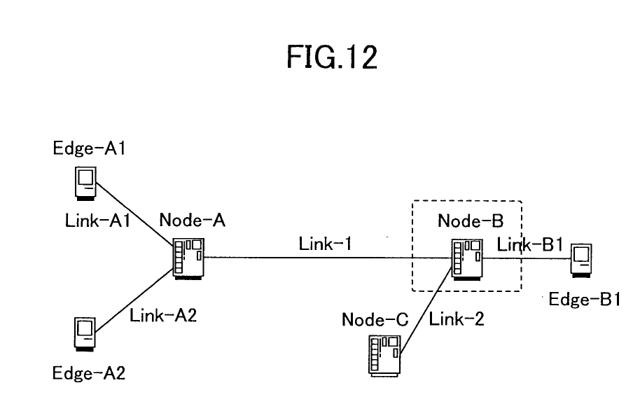

FIG. 12 is a diagram illustrating the change of registered information of Node-B according to the embodiment of the present invention. The displaying method of node and link is the same as shown in FIG. 2 and there is shown the display screen of the network operation monitoring system 10. A node change sequence is initiated by the operator operating the manipulation unit 15. The control unit 14 changes to the node registration change process when it receives the sequence.

In FIG. 12, Node-A and Node-B are connected to each other via Link-1. Node-B and Node-C are connected to each other via Link-2. Edge-A1 is connected to Node-A via Link-A1 and Edge-A2 is connected to Node-A via Link-A2. Edge-B1 is connected to Node-B via Link-B1.

The following is the change sequence of the registered information of Node-B. The subject of the operations is the network operation monitoring system 10.

1. Move the information of Node-B up to the present to the information in the past 50 to change the information of Node-B.

2. Store the information of Node-B after the change in the information at the present 40. The storage fields for this information are in the event-recording database 11A.

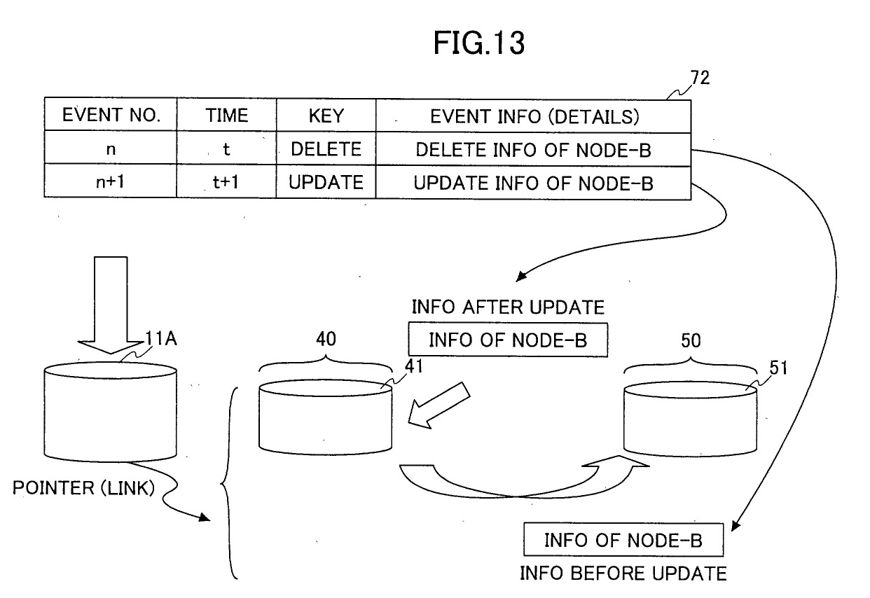

FIG. 13 is a diagram illustrating the change of the registered information of the node and updating of the event-recording database 11A according to the embodiment of the present invention. Elements identical to those shown in FIG. 7 are denoted with the same reference numerals. In FIG. 13, a sequence 72 represents the change of Node-B as shown in FIG. 12. The event number, the time information, the key information, and the event information (details) with respect to each event are stored in the event-recording database 11A. At event number n, an event of deleting the information of Node-B occurs at time t (Key is to delete). Since the information of Node-B is to be deleted, it is moved from the group of node objects 41 of the information at the present 40 to the group of node object 51 of the information in the past 50.

At event number n+l, an event of updating the information of the node occurs at time t+1 (Key is to update). In this case, the updated information of Node-B is registered to the group of node objects 41 of the information at the present 40.

For changing the registered information of Node-B, the contents of the sequence 72 are stored in each record of the event-recording database 11A and the detailed information of each record is associated with each group of objects by a pointer (link). Therefore, it is possible to read out the contents of the event-recording database 11A and display them on the display screen (display unit 13).

The retrieval of the network status at any point of time in the past is enabled by tracing, in the reverse direction, the information recorded in the event-recording database 11A from the point of time when the information of an overall operating condition of the network is defined (for example, the present) to the past. However, when the time difference between the present (reference time) and the past (the time to be referred to) is large, it is necessary to retrieve a large number of events occurred between the reference time and the time to be referred to in order to grasp the operating condition of the past to be referred to and therefore this is not practical in real usage.

In order to solve such a problem, the overall network operating condition is recorded on a regular basis. Therefore, the network status of a point of time in the past to be referred to is retrieved by having, as a reference, the overall network operating condition recorded at a point of time closest to the point of time in the past to be referred to.

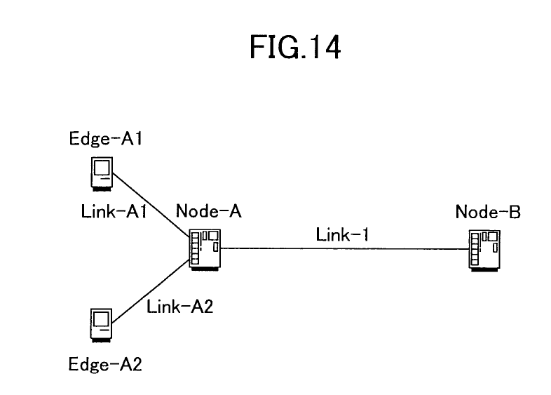

FIG. 14 is a diagram illustrating the recording of the network status according to the embodiment of the present invention. The displaying method of the node and the link is the same as shown in FIG. 2 and there is shown the display screen of the network operation monitoring system 10. A network status recording sequence is initiated by the operator operating the manipulation unit 15. The control unit 14 changes to the network status recording process when it receives the sequence.

In FIG. 14, Node-A and Node-B are connected to each other via Link-1. Node-A and Edge-Al are connected to each other via Link-A1. Node-A and Edge-A2 are connected to each other via Link-A2.

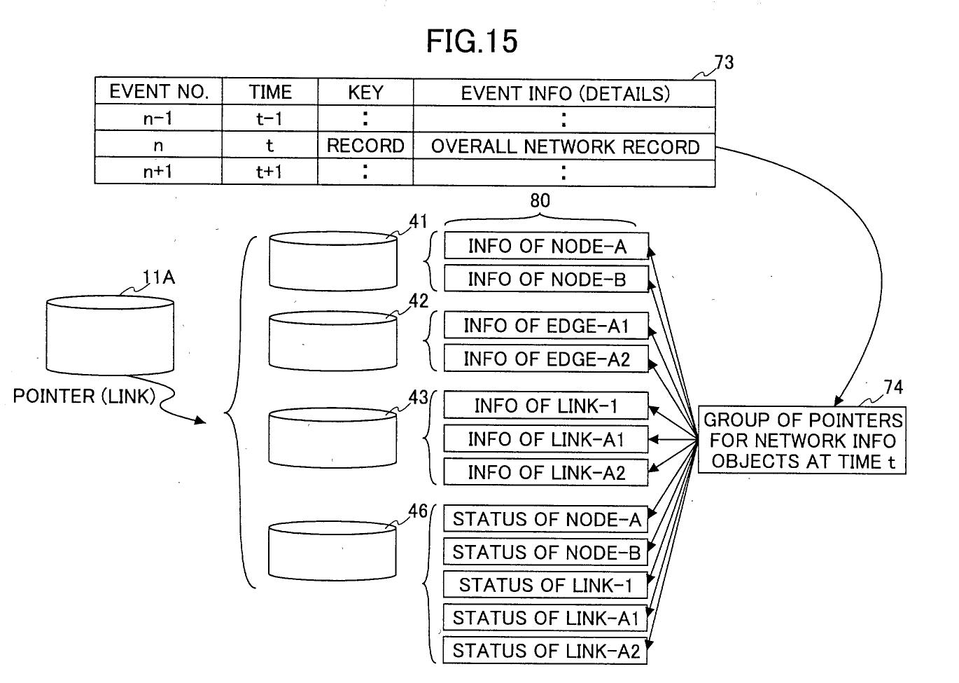

FIG. 15 is a diagram illustrating the recording of the network status and the recording of network information objects at time t according to the embodiment of the present invention. In FIG. 15, a sequence 73 represents the recording of the operating condition of the whole network all at once at time t. The information of Node-A and the information of Node-B shown in FIG. 14 are branched into information entities 80 via a group of pointers 74 for the network information objects at time t.

The information of Node-A and the information of Node-B, which are both the information entities 80, are stored in the group of node objects 41 of the information at the present 40. The information of Edge-A1 and the information of Edge-A2 are stored in the group of edge objects 42 of the information at the present 40. Further, the information of the Link-1, the information of the Link-A1, and the information of Link-A2 are stored in the group of physical link objects 43 of the information at the present 40. Finally, the status of Node-A, the status of Node-B, the status of Link-1, the status of Link-A1, and the status of Link-A2 are stored in the group of the status objects 46 of the information at the present 40.

At each change, the contents of the sequence 73 are stored in each record of the event-recording database 11A and the detailed event information of each record is associated with each group of objects by a pointer (link). Therefore, the control unit 14 can read out the contents of the event-recording database 11A and display them on the display screen (display unit 13).

The following is a description of the retrieval of the network status. In order to retrieve the network status at a point of time in the past (retrieval time “t0”), a point of time “ts” (retrieval reference time) closest to the retrieval time “t0”, when “an overall network record” is recorded, is searched for in the event-recording database 11A.

Since “the overall network record” comprises all the information concerning the network, it is possible to immediately retrieve the status at the time “ts”. In order to obtain the status of the retrieval time “t0” from the retrieval reference time “ts”, all the events occurred between the time “ts” and the time “t0” are sequentially retrieved starting from the time “ts” and are reflected to the network status retrieved at the time ts. When “t0” >“ts”, the network status of the retrieval time “t0” is obtained by updating the network status in the order in which the events occurred. When “ts”>“t0”, the network status of the retrieval time “t0” is obtained by updating the network status in the reverse order in which the events occurred.

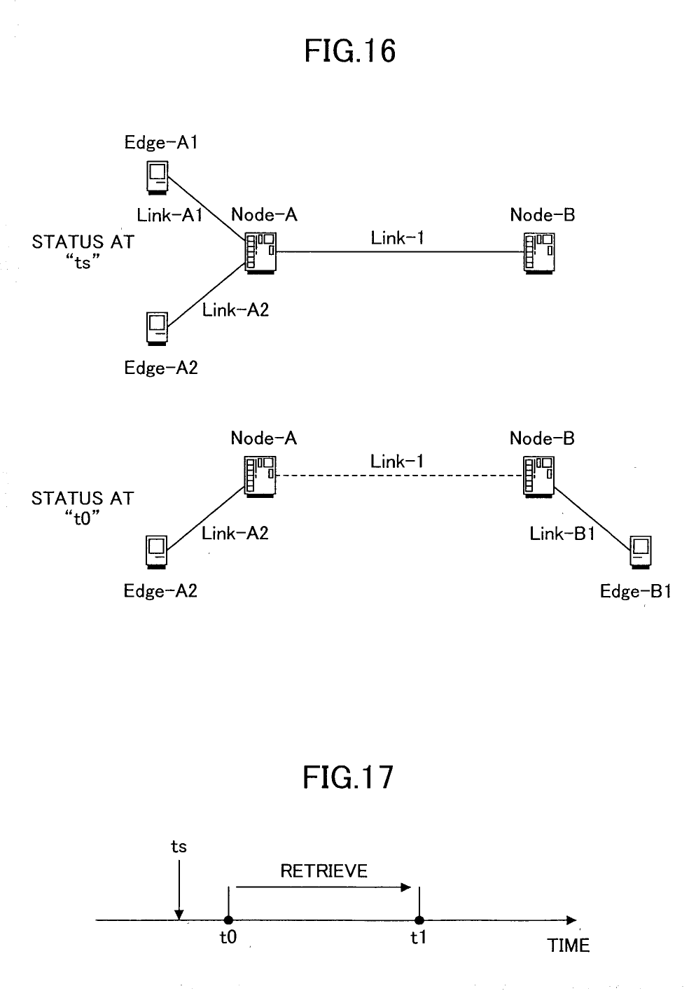

FIG. 16 is a diagram illustrating the retrieval of the network status according to the embodiment of the present invention. The displaying method of the node and the link is the same as shown in FIG. 2 and there is shown the display screen of the network operation monitoring system 10. A network status retrieval sequence is initiated by the operator operating the manipulation unit 15. The control unit 14 changes to the network status retrieval process when it receives the sequence.

In FIG. 16, the network status of time “ts” and the network status of the time “t0” are shown. The time “ts” is the retrieval reference time and the time “t0” is the retrieval time.

In the network status of the time “ts”, Node-A and Node-B are connected to each other by Link-1. Edge-A1 is connected to Node-A via Link-A1 and Edge-A2 is connected to Node-A via Link-A2. Whereas in the network status of the time “t0”, there is a failure in Link-1 connecting Node-A and Node-B. In addition, Edge-B1 and Link-B1 connecting Edge B1 to Node-B are added.

FIG. 17 is a diagram illustrating the retrieval of the network status according to the embodiment of the present invention. In FIG. 17, t0 represents the time when the retrieval starts and t1 represents the time when the retrieval stops. According to FIG. 17, the statuses between the time t0 and the time t1 are retrieved based on a reference time “ts”. The horizontal axis in FIG. 17 represents time. By doing so, it is possible to retrieve and display the network operating condition using a unit for designating a specific time, event, or status.

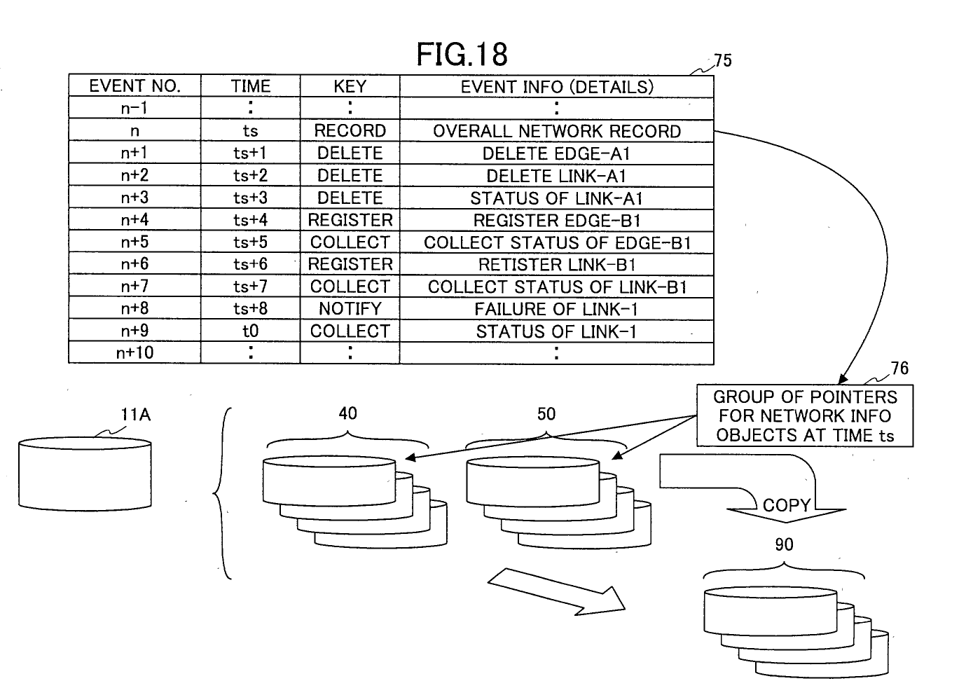

FIG. 18 is a diagram illustrating the recording and the retrieval of the network status and describing the procedure of retrieving the network status at the retrieval start time t0 from the retrieval reference time “ts” shown in FIG. 16 and FIG. 17. Elements identical to those shown in FIG. 7 are denoted with the same reference numerals. In FIG. 18, a sequence 75 represents the storage of the transition with respect to each event. The reference numeral 40 represents information at the present, the reference numeral 50 represents information in the past, and the reference numeral 90 represents working areas for retrieval. The reference numeral 11A represents the event-recording database. The following is a description of the sequence 75.

1. Event number n: Information of the overall network record at time “ts” is retrieved, a copy of which is stored in the working areas 90 for retrieval (Key is to record). The subsequent retrieval operations are performed by updating the information stored in the working areas 90. The reason for this is to prevent damaging the contents in the information at the present 40 and the information in the past 50.

In this case, a group of pointers 76 for the network information objects at time “ts” is created and associated with the groups of the objects of the information at the present 40 and of the information in the past 50. In short, the information of the overall network record is recorded in the information at the present 40 at time “ts” and when the next event occurs, the information recorded at time “ts” is moved to the information in the past 50.

2. Event number n+1: The registered information of Edge-A1 is deleted at time ts+1 (Key is to delete).

3. Event number n+2: The registered information of Link-A1 is deleted at time ts+2 (Key is to delete).

4. Event number n+3: The status information of Link-A1 is deleted (Key is to delete).

5. Event number n+4: Edge-B1 is registered at time ts+4 by making reference to the objects recorded as information at the present or the past (Key is to register).

6. Event number n+5: The status of Edge-B1 is recorded at time ts+6 by making reference to the objects recorded as information at the present or the past (Key is to collect).

7. Event number n+6: Link-B1 is registered at time ts+6 by making reference to the objects recorded as information at the present or the past (Key is to register).

8. Event number n+7: The status of Link-B1 is registered at time ts+7 by making reference to the objects recorded as information at the present or the past (Key is to collect).

9. Event number n+8: The status of Link-1 (the physical link having a failure) is updated at time ts+8 by making reference to the objects recorded as information at the present or the past (Key is to notify).

Finally, at event number n+9, the status of the physical link of Link-1 is obtained (Key is to collect). By following this procedure, it is possible to retrieve the status at the designated retrieval start time t0.

At each change, the contents of the sequence 75 are recorded in each record of the event-recording database 11A and the detailed information of each record is associated with each group of objects by a pointer (link). As a result, information recorded in the event-recording database 11A is read out by the control unit 14 and displayed by the display unit 13 through retrieval unit 12.

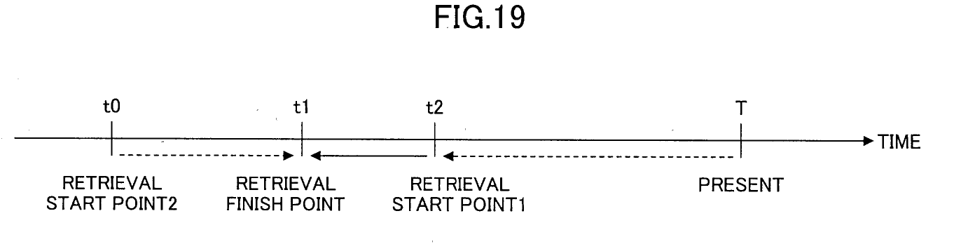

FIG. 19 is a diagram illustrating the retrieval of the network status in the past according to the embodiment of the present invention. The horizontal axis in FIG. 19 represents time. The left hand side of FIG. 19 represents the past and the right hand side of FIG. 19 represents the present. In FIG. 19, T represents the present, t0 and t2 represent the retrieval start times designated by the operator, and t1 represents the retrieval finish time designated by the operator. In order to observe the transition in the network status from t0 to t1, first, the status at t0 is displayed on the display screen. Then, the transition in the status is sequentially retrieved and displayed on the display screen by retrieving information from the event-recording database 11A shown in FIG. 7 in the order that the events occurred.

At this time, retrieving of the information from the event-recording database and displaying of the information are controlled by a display rate indicated by the operator. The same applies to the case when the transition in the network status tracing back from t2 to t1 is to be observed. The transition in the status from t2 to t1 can be traced back by retrieving information from the event-recording database 11A in the reverse order that the events occurred.

As mentioned in detail, according to the present invention, by providing a unit for making a reference time interval at the time of display variable with respect to the real time when retrieving and displaying the events occurred in the network on the monitoring screen, it is possible to vary the display rate.

Therefore, it is possible to display the network status information with different display rates.

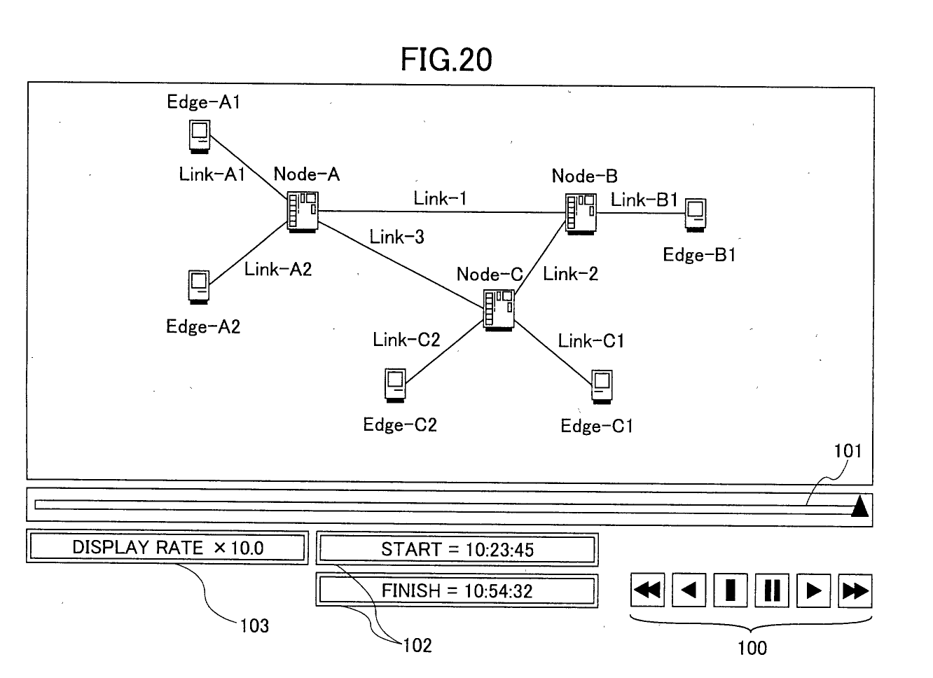

FIG. 20 shows a first example of the network status display screen according to the embodiment of the present invention. The displaying method of the node and the link is the same as shown in FIG. 2 and there is shown the display screen of the network operation monitoring system 10. The display screen of the network operation monitoring system 10 is provided with a set of display control buttons 100 for retrieving and displaying the network operating condition from the past until the present, a display control slider 101 for representing the relative time of the current screen, a display rate display section 103, and a time display section 102 having a retrieval start button and a retrieval finish button.

The network operating condition at any point in time from the past to the present can be easily searched for and retrieved by the operator operating (clicking, for example) one of the mentioned buttons. For example, the set of display control buttons 100 includes icons representing forward retrieval (reproduction), reverse retrieval (reproduction), pause, stop, fast-reverse, and fast-forward as with a tape recorder and a predetermined corresponding process is performed by the operator clicking on one of these icons.

The time display section 102 displays retrieval start time and retrieval finish time. The display rate display section 103 shows information indicating the increase of the display rate with respect to the normal display rate. Fast-forward retrieval is enabled in consideration of the large amount of time consumed in the case of retrieval in the normal display rate.

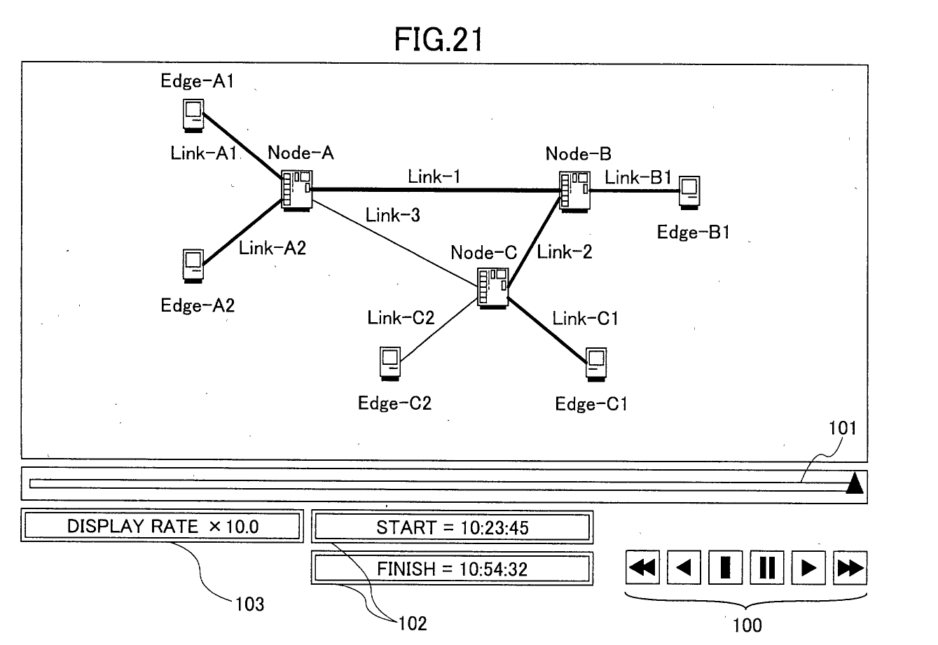

FIG. 21 shows a second example of the network status display screen according to the embodiment of the present invention. Elements identical to those shown in FIG. 20 are denoted with the same reference numerals. In this example, the display screen-of the network operation monitoring system 10 displays the traffic status of each line (link) as the thickness of its displayed line. The thickness of the displayed line of each line (link) varies in proportion to the average line usage rate (line occupation rate) with respect to the predetermined capacity of the line (link).

The traffic status of the network at any point in time from the past to the present can be obtained as an overall picture of the network by the operator operating the set of display control buttons 100.

According to the present invention, since the amount of traffic of each line (link) is retrieved and displayed in accordance with the thickness of the display line representing the line (link) displayed on the screen, it is easy for the operator to grasp the overall picture of the network.

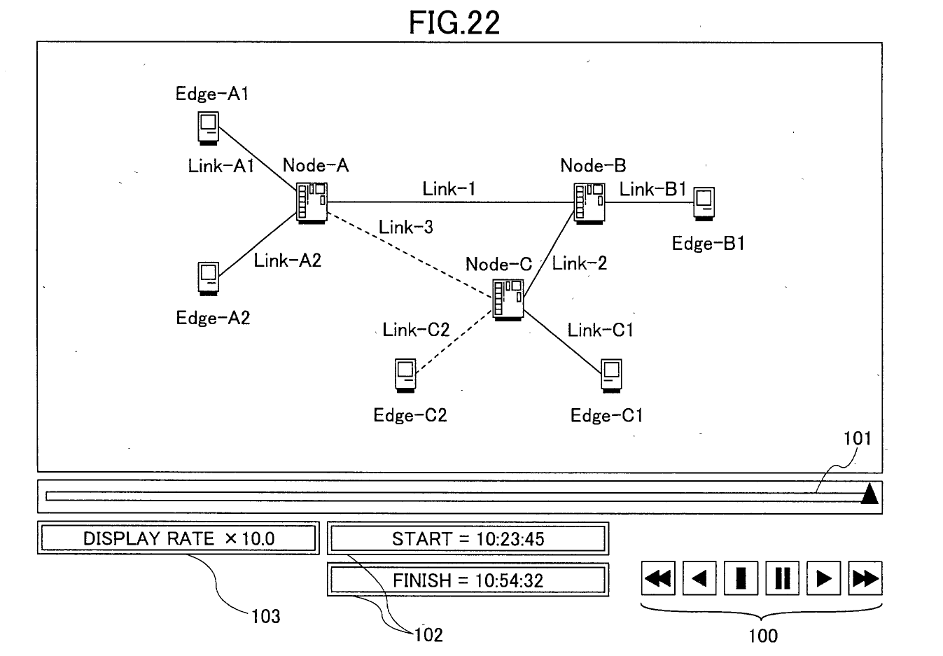

FIG. 22 shows a third example of the network display screen according to the embodiment of the present invention. Elements identical to those shown in FIG. 20 are denoted with the same reference numerals. In this example, the traffic status of each line (link) is differentiated with a different color instead of the thickness of the display line of each line (link). For example, a line (link) with heavy traffic (high occupation rate) is displayed as red (it is shown in FIG. 22 as a solid line) and a line (link) with little traffic (low occupation rate) is displayed as blue (it is shown in FIG. 22 as a broken line).

According to such examples, it is possible to retrieve and display the amount of the traffic in the network by the different colors representing respective statuses.

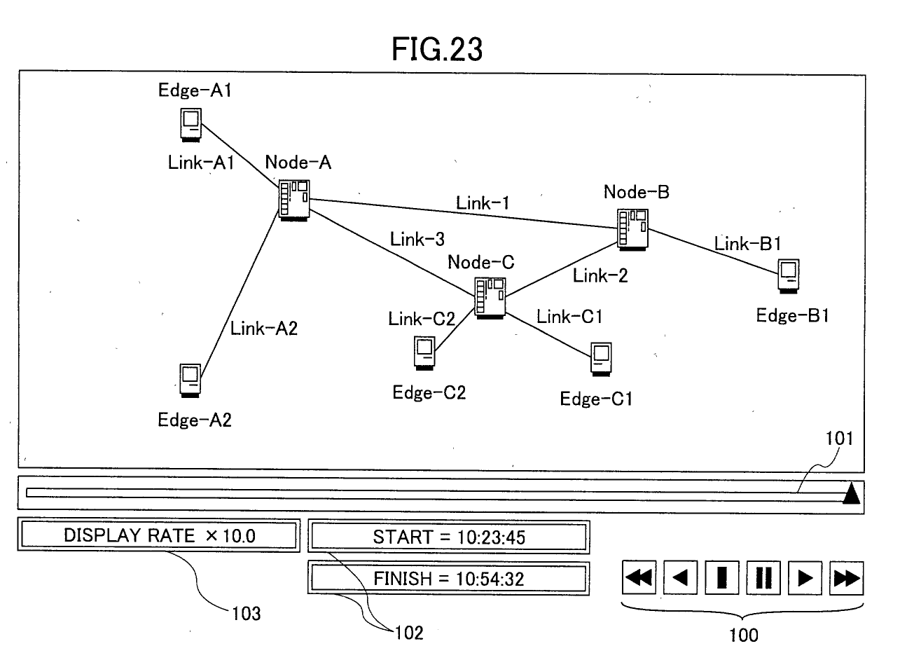

FIG. 23 is a fourth example of the network status display screen according to the embodiment of the present invention. Elements identical to those shown in FIG. 20 are denoted with the same reference numerals. In this example, the display screen of the network operation monitoring system 10 displays the status of the response time of respective nodes as distance between the relevant nodes. The transition in the response time of respective nodes is reflected on the display screen such that the nodes having longer response time are displayed with a larger distance on the screen and the nodes having shorter response time are displayed with a smaller distance on the screen. The status of the response time of the nodes in the network at any point in time from the past to the present can be obtained as an overall picture of the network by the operator operating the set of display control buttons 100. The response time status may be displayed as links with different colors. For example, a green colored link may represent faster response time and a red colored link may represent slower response time.

According to the present invention, the response time can be retrieved and displayed as the distance (length of the link) between the nodes or as the different colored links.

As mentioned above in detail, the present invention excels in the disconnecting of failure location at the time of failure, the grasp of utilization status, and the grasp of the present status for the expansion of the network in the future and thus largely contributes to stable operation of the network; therefore it has a large effect in practical usage.

Also, the present invention is able to retrieve and display the events occurred in the network in the past in the network physical configuration and in the network logical configuration. In the above examples, the descriptions are made mainly based on the logical configuration, however, it is also possible to retrieve and display based on the physical configuration.

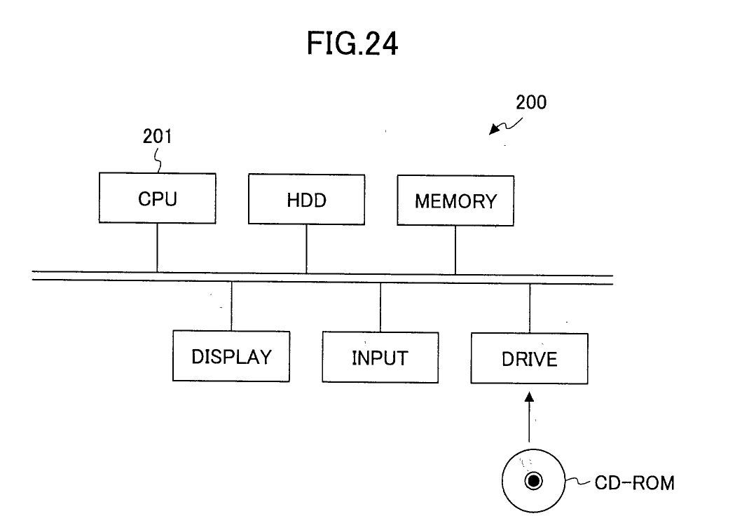

It is to be noted that the present invention may also be embodied as a software program stored on a computer-readable transportable information storage medium (such as CD-ROMs, etc.). The software program stored on the medium is executed by a central processing unit (CPU) 201 in a personal computer 200 when the media is loaded into a drive of the personal computer (see FIG. 24).

Further, the present invention is not limited to the above-described embodiments, and variations and changes may be made without departing from the scope of the present invention.

The present application is based on Japanese priority application No. 2002-213291, filed on Jul. 23, 2002, the entire contents of which are hereby incorporated by reference.

What is claimed is

1. A network operation monitoring system comprising:
a memory unit for storing network status information in a time series with respect to each operation performed by an operator on a network or with respect to each transition in events;
a retrieval unit for retrieving said network status information stored in said memory unit in a time-dependant manner according to the operator's instruction; and
a display unit for displaying said network status information retrieved by said retrieval unit in the time-dependant manner according to the operator's instruction.

2. The system as claimed in claim 1, wherein the storage of said network status information in said memory unit is realized by storing a record, for each event, comprising an event number, time information, key information, and event information, and network information comprising network configuration information having information at the present and the information in the past, and history information.

3. The system as claimed in claim 2, wherein said event number comprises a serial value of said record, said time information indicates a time when said event occurred, said key information comprises additional information for a search or marking said event, and said event information comprises detailed information of said event.

4. The system as claimed in claim 2, wherein said event information in the record is associated with the network information.

5. The system as claimed in claim 1, said system further comprising a unit for designating a certain event or certain network status information as a retrieval start point and a retrieval finish point when displaying said network status information retrieved in the time-dependant manner according to the operator's instruction.

6. The system as claimed in claim 1, said system further comprising a unit for controlling a display rate with respect to real event progress time scale when displaying said network status information retrieved in the time-dependant manner according the operator's instruction.

7. The system as claimed in claim 1, said system further comprising a unit for displaying said network status information retrieved in the time-dependant manner according to the operator's instruction with respect to a network physical configuration or a network logical configuration.

8. The system as claimed in claim 1, said system further comprising a unit for controlling display manner of measured status with respect to the network.

9. The system as claimed in claim 8, wherein the measured status with respect to the network comprises measured response time of a node, and is represented as distance between nodes or as color of a display line connecting said nodes displayed on said display unit in proportion to the response time when displaying said network status information in the time-dependant manner according to the operator's instruction.

10. The system as claimed in claim 9, wherein said node comprises a communication device.

11. The system as claimed in claim 9, wherein said node comprises a router or a switch.

12. The system as claimed in claim 8, wherein the measured status with respect to the network comprises an amount of traffic of a link connecting between nodes in said network, and is represented as color or thickness of a display line representing said link displayed on said display unit in proportion to the amount of traffic when displaying said network status information retrieved in the time-dependant manner according to the operator's instruction.

13. The system as claimed in claim 12, wherein said node comprises a communication device.

14. The system as claimed in claim 12, wherein said node comprises a router or a switch.

15. A network operation monitoring method comprising the steps of:
storing network status information in a time series with respect to each operation performed by an operator on a network or with respect to each transition in events;
retrieving said network status information stored in said storing step in a time-dependant manner according to the operator's instruction; and
displaying said network status information retrieved in said retrieving step in the time-dependant manner according to the operator's instruction.

16. The method as claimed in claim 15, wherein said storing step is realized by storing a record, for each event, comprising an event number, time information, key information, and event information, and network information comprising network configuration information having information at the present and the information in the past, and history information.

17. The method as claimed in claim 16, wherein said event number comprises a serial value of said record, said time information indicates a time when said event occurred, said key information comprises additional information for a search or marking said event, and said event information comprises detailed information of said event.

18. The method as claimed in claim 16, wherein said event information in the record is associated with the network information.

19. The method as claimed in claim 15, said method further comprising a step of controlling display manner of measured status with respect to the network.

20. The method as claimed in claim 19, wherein the measured status with respect to the network comprises measured response time of a node in said network, and is represented as distance between nodes or as color of a display line connecting said nodes displayed on said display unit in proportion to the response time when displaying said network status information in the time-dependant manner according to the operator's instruction.

21. The method as claimed in claim 19, wherein the measured status with respect to the network comprises an amount of traffic of a link connecting between nodes in said network, and is represented as color or thickness of a display line representing said link displayed on said display unit in proportion to the amount of traffic when displaying said network status information retrieved in the time-dependant manner according to the operator's instruction.

22. A computer readable program comprising instructions to make a computer execute the functions of:
a) storing network status information in a time series with respect to each operation performed by an operator on a network or with respect to each transition in events;
b) retrieving said network status information stored by said function a) in a time-dependant manner according to the operator's instruction; and
c) displaying said network status information retrieved by said function b) in the time-dependant manner according to the operator's instruction.

23. The program as claimed in claim 22, wherein the storage of said network status information by said function a) is realized by storing a record, for each event, comprising an event number, time information, key information, and event information, and network information comprising network configuration information having information at the present and the information in the past, and history information.

24. The program as claimed in claim 23, wherein said event number comprises a serial value of said record, said time information indicates a time when said event occurred, said key information comprises additional information for a search or marking said event, and said event information comprises detailed information of said event.

25. The program as claimed in claim 23, wherein said event information in the record is associated with the network information.

26. The program as claimed in claim 22, wherein said program further makes the computer execute the function of d) controlling display manner of measured status with respect to the network.

27. The program as claimed in claim 26, wherein the measured status with respect to the network comprises measured response time of a node in said network, and is represented as distance between nodes or as color of a display line connecting the nodes displayed on said display unit in proportion to the response time when displaying said network status information in the time-dependant manner according to the operator's instruction.

28. The program as claimed in claim 26, wherein the measured status with respect to the network comprises an amount of traffic of a link connecting between nodes in said network, and is represented as color or thickness of a display line representing said link displayed on said display unit in proportion to the amount of traffic when displaying said network status information retrieved in the time-dependant manner according to the operator's instruction.

29. A computer readable information storage medium having a program stored therein comprising instructions to make a computer execute the functions of:
a) storing network status information in a time series with respect to each operation performed by an operator on a network or with respect to each transition in events;
b) retrieving said network status information stored by said function a) in a time-dependant manner according to the operator's instruction; and
c) displaying said network status information retrieved by said function b) in the time-dependant manner according to the operator's instruction.

30. The medium as claimed in claim 27, wherein the storage of said network status information by said function a) is realized by storing a record, for each event, comprising an event number, time information, key information, and, event information, and network information comprising network configuration information having information at the present and the information in the past, and history information.

31. The medium as claimed in claim 30, wherein said event number comprises a serial value of said record, said time information indicates a time when said event occurred, said key information comprises additional information for a search or marking said event, and said event information comprises detailed information of said event.

32. The medium as claimed in claim 30, wherein said event information in the record is associated with the network information.

33. The medium as claimed in claim 29, wherein said program further makes the computer execute the function d) controlling display manner of measured status with respect to the network.

34. The medium as claimed in claim 33, wherein the measured status with respect to the network comprises measured response time of a node in said network, and is represented as distance between nodes or as color of a display line connecting the nodes displayed on said display unit in proportion to the response time when displaying said network status information in the time-dependant manner according to the operator's instruction.

35. The medium as claimed in claim 33, wherein the measured status with respect to the network comprises an amount of traffic of a link connecting between nodes in said network, and is represented as color or thickness of a display line representing said link displayed on said display unit in proportion to the amount of traffic when displaying said network status information retrieved in the time-dependant manner according to the operator's instruction.
